(19) United States
(12) Patent Application Publication
(10) Pub. No.: US 2022/0252348 A1
(43) Pub. Date: Aug. 11, 2022

(54) HEAT TREATMENT MEMBER AND HEAT TREATMENT STRUCTURE

(71) Applicant: NIKKO KINZOKU CO., LTD., Tochigi (JP)

(72) Inventor: Etsuo INOUE, Tochigi (JP)

(21) Appl. No.: 17/612,977

(22) PCT Filed: Feb. 25, 2021
(86) PCT No.: PCT/JP2021/006955

§ 371 Date: Nov. 19, 2021

(30) Foreign Application Priority Data
Feb. 26, 2020 (JP) 2020-031087

(51) Int. Cl. F27D 3/12; C21D 1/06; C23C 8/20

(52) U.S. Cl. CPC F27D 3/12; C23C 8/20; C21D 1/06

(57) ABSTRACT

To provide a heat treatment member and the like that, even when repeatedly loaded into a heat treating furnace, suppresses the occurrence of deformation, cracking, and the like, allowing use for a prolonged period of time, and enables uniform and sufficient carburizing treatment of a part to be heat-treated. The above-described problem is solved by a heat treatment member constituting a heat treatment structure repeatedly loaded into a heat treating furnace with a part to be heat-treated placed thereon, hooked thereto, or the like, comprising an ST member composed of a steel material or a Ni alloy material and a CC member composed of a carbon composite material being detachably combined. At this time, the ST member is preferably a member fabricated by a lost wax process, and the heat treatment member is preferably a hooking member for hooking the part to be heat-treated, a support member for supporting the hooking member, a mounting member for mounting the part to be heat-treated, or a stacking auxiliary member or a support column member for stacking each of these members.

### FIELD OF THE INVENTION

The present invention relates to a heat treatment member and a heat treatment structure. More specifically, the present invention relates to a heat treatment member that, even when repeatedly loaded into a heat treating furnace with a part to be heat-treated placed thereon, hooked thereto, or the like in order to heat-treat the part to be heat-treated, suppresses the occurrence of deformation, cracking, and the like, allowing use for a prolonged period of time, and a heat treatment structure obtained by combining the same.

### BACKGROUND ART

Carburizing treatment is known as a surface hardening treatment for metal parts. Carburizing treatment is a treatment in which carbon monoxide (CO) gas generated from a carburizing agent and a steel material are brought into contact at a high temperature, thereby introducing and diffusing the carbon into the metal parts to form a surface layer (carburized layer). In particular, for metal parts composed of a low carbon steel or the like having a low carbon content, only the surface layer hardens when quenching and tempering are performed after the carburizing treatment. As a result, the obtained metal product is constituted by a surface layer having wear resistance and a core rich in toughness.

In a carburizing treatment, members (carburizing furnace members) such as trays and grids for placing metal parts, which are materials to be treated, are used. The carburizing furnace members are exposed to a carburizing gas in the carburizing furnace at 800 to 1000° C. for an extended period of time. Further, the carburizing furnace members are repeatedly used, and thus are repeatedly exposed to the carburizing gas at high temperatures. Furthermore, the carburizing furnace is, in general, repeatedly heated and cooled, and thus the carburizing furnace members are placed in extremely severe temperature environments.

Therefore, an austenitic stainless steel or a heat-resistant cast steel excellent in high-temperature strength and high-temperature oxidation resistance is generally used for the carburizing furnace members. However, even if constituted by these steel materials, the carburizing furnace members tend to crack, deform, and the like due to repeated carburizing treatments and have short service lives.

The cracking, deformation, and the like of the carburizing furnace members mainly occur due to two causes. The first cause is that the carburizing treatment is repeatedly performed, thickly forming a hard and brittle carburized layer containing chromium carbide or cementite on the steel material constituting the carburizing furnace members. A carburizing furnace member with a thick carburized layer formed is likely to deform or crack due to expansion and contraction stresses associated with heating and cooling. A deformed or cracked carburizing furnace member may eventually break and become unusable.

The second cause is that the carburizing treatment is further repeatedly performed, growing the chromium carbide or the cementite over the entire carburized layer formed thickly on the carburizing furnace members, and expanding a volume of the carburized layer. The overall shape of each of the carburizing furnace members is greatly deformed due to the expansion of the volume of the carburized layer. Then, a largely deformed carburizing furnace member becomes difficult to use and, if an attempt is made to remedy the deformation, the carburized layer, being fragile, may break.

In response to such problems, it has been conventionally proposed to manufacture the carburizing furnace member using an alloy having improved heat resistance and carburization resistance. For example, in Patent Document 1, there is proposed a heat-resistant alloy having excellent high-temperature strength and corrosion resistance, and having excellent carburization resistance and coking resistance even in a pyrolysis environment in which carburizing and oxidation are repeated. In Patent Document 2, there is proposed a calorizing treatment for the purpose of providing a member or jig that can be stably used for a prolonged period of time in a gas carburizing furnace under a severe thermal shock environment. This calorizing treatment improves the carburization resistance of the member or the jig subjected to the calorizing treatment, is stable with almost no carburizing even when used for a prolonged period of time in a gas carburizing furnace in a severe environment, and thus can significantly extend the service life of the member or the jig. Further, this applicant, in Patent Document 3, has proposed a technique capable of imparting excellent carburization resistance at low cost to an iron alloy base material constituting a carburizing furnace member (a member such as a tray or a grid) used in a carburizing furnace.

In Patent Document 4, there is proposed use of a C/C composite, which is a carbon-based composite material, instead of stainless steel or a heat-resistant cast steel as the material of a jig for heat treatment used in a carburizing treatment, a carbonitriding treatment, or the like. It is said that, with such material changes, the jig for heat treatment is not affected by the carburizing or the nitriding, has excellent high-temperature strength, has excellent durability to withstand thermal shock during rapid heating and quenching, and does not thermally deform, making it possible to decrease a heat capacity thereof on the basis of weight saving. In Patent Document 5, it is said that the tray on which the parts to be treated are placed is formed of a carbon-based composite material (C/C composite), thereby preventing carburizing of the tray and extending the service life thereof. Furthermore, it is said that a spacer plate made of a carburizing-retardant material is interposed between the tray formed of the carbon-based composite material and the parts to be treated, and thus the carbon component contained in the carbon-based composite material does not adversely affect the parts to be treated.

### PRIOR ART DOCUMENTS

### Patent Documents

Patent Document 1: Japanese Laid-Open Patent Application No. H05-033092

Patent Document 2: Japanese Laid-Open Patent Application No. H10-168555

Patent Document 3: Japanese Patent No. 5469274

Patent Document 4: Japanese Laid-Open Patent Application No. 2001-123219

Patent Document 5: Japanese Laid-Open Patent Application No. 2004-107705

### SUMMARY OF THE INVENTION

### Problems to be Solved by the Invention

Nevertheless, the techniques of Patent Document 1 and Patent Document 2 use a high-cost nickel-based heat-resistant alloy, or apply a calorizing treatment using a special treating agent, a container, and the like, significantly increasing the manufacturing cost of the carburizing furnace member. The technique of Patent Document 3 is a treatment method capable of imparting excellent carburization resistance to the carburizing furnace member at low cost, but demands the ability to use the tray member for a prolonged period of time and demands further added value and cost reduction.

It is said that, in the technique of Patent Document 4, a jig for heat treatment such as a tray is fabricated using a C/C composite, thereby making it possible to improve durability and realize a prolonged service life. However, the technique only demands the placement of many parts to be heat-treated on the tray to efficiently carry out heat treatment, and there is no mention of quality in relation to a carburization. In Patent Document 5, it is said that the spacer plate made of a carburizing-retardant material is interposed between the tray formed of the carbon-based composite material and the parts to be treated, thereby keeping the carbon component contained in the carbon-based composite material from adversely affecting the parts to be treated. However, because the parts to be heat-treated are randomly placed on the spacer plate constituted by a carburizing-retardant material, the parts to be heat-treated may come into contact with each other and carburizing may be insufficient at contacting portions thereof.

Particularly in recent years, along with the demand for prolonging the service life of jigs for heat treatment, there has been a demand for heat-treating a large number of parts to be heat-treated at once, even if the shapes are complex. This makes it necessary to precisely process integrated part receivers having a complex shape at a narrow pitch. Furthermore, there has also been a demand for heat-treating many types of parts to be heat-treated together. Nevertheless, even if the part receivers are precisely processed at a narrow pitch, when the part receivers gradually deform due to heat treatment, the precision can no longer be ensured, making use no longer possible.

Further, as illustrated in FIGS. 12A and 12B, FIG. 13, and FIG. 14, heat treatment members 10′ (10A′, 10B′, 10C′, 10D′, 10E′) currently used are all constituted by a steel material and therefore, in part or in whole, are susceptible to thermal deformation and thus susceptible to deformation, distortion, cracking, and the like, shortening the overall service life.

The present invention has been made to solve the above-described problems, and an object thereof is to provide a heat treatment member that, even when repeatedly loaded into a heat treating furnace with a part to be heat-treated placed thereon or hooked thereto in order to heat-treat the part to be heat-treated, suppresses the occurrence of deformation, cracking, and the like, allowing use for a prolonged period of time, and enables uniform and sufficient carburizing treatment of the part to be heat-treated, and a heat treatment structure obtained by combining the heat treatment members.

### Means for Solving the Problems

(1) A heat treatment member according to the present invention is a heat treatment member constituting a heat treatment structure repeatedly loaded into a heat treating furnace with a part to be heat-treated placed thereon or hooked thereto, comprising a member composed of a steel material or a Ni alloy material, and a member composed of a carbon composite material being detachably combined. It should be noted that, in the following, a member composed of a steel material or a Ni alloy material is also referred to as an “ST member (steel member),” and a member composed of a carbon composite material is also referred to as a “CC member.”

According to this invention, (a) the heat treatment member is a member configured by combining the ST member and the CC member and not an integrated structure such as in the conventional technique, making it possible to simplify each member structure and achieve a reduction in man-hours and decrease manufacturing costs in comparison to the conventional technique. (b) The CC member is a carbon composite material that has heat resistance and does not readily thermally deform and thus, when the combined heat treatment member is to be repeatedly loaded into a heat treating furnace for a prolonged period of time, a portion in which deformation, cracking, and the like are likely to occur and likely to affect the quality of the part to be heat-treated is used as the CC member, which is a separate member, allowing repeated use for a prolonged period of time. (c) The ST member and the CC member are separate members that can be combined and thus, by using a member having a complex structure as the low-cost ST member susceptible to deformation and the like but easy to process, it is possible to replace the ST member only with a spare part as needed.

In the heat treatment member according to the present invention, the member composed of a steel material or a Ni alloy material is a member fabricated by a lost wax process.

The manufacturing method of the ST member is not particularly limited, but according to this invention, the ST member is fabricated by the lost wax process, which is a preferable manufacturing method. Thus, while susceptible to deformation and the like, the member can be replaced with a spare part having high accuracy at low cost.

In the heat treatment member according to the present invention, the heat treatment member is a hooking member for hooking the part to be heat-treated, a support member for supporting the hooking member, a mounting member for mounting the part to be heat-treated, a stacking auxiliary member for stacking each of these members, or a support column member for stacking each of these members.

According to this invention, it is possible to preferably apply the heat treatment member to these members and thus save a weight of the heat treatment structure constituted by these members as a whole and continue use for a prolonged period of time while replacing the ST member as needed. It should be noted that the hooking member may be a member for hooking a plurality of the parts to be heat-treated at the same time, or may be a member for hooking an individual part to be heat-treated. Further, examples of the stacking auxiliary member include a support column provided at a corner, a center, or the like, in a case in which a mounting member having a tray shape is vertically stacked, a member sandwiched between the mounting members, and the like.

In the heat treatment member according to the present invention, preferably a member detachably mounted on another member (including another heat treatment member) among the heat treatment members is the member composed of a steel material or a Ni alloy material.

According to this invention, although susceptible to deformation and the like in comparison to the CC member, the ST member has favorable wear resistance, high strength, and low cost and thus, by using a member detachably mounted on another member (including another heat treatment member) as the ST member, can be replaced with a spare ST member having high wear resistance at low cost.

In the heat treatment member according to the present invention, the member composed of a steel material or a Ni alloy material and the member composed of a carbon composite material are attached and detached by means selected from screw fastening and unfastening using a screw fastening member, welding and welded-part removal using a welding auxiliary member, and engagement and disengagement of the members.

According to this invention, the attachment and detachment is performed by screw fastening and unfastening, welding and welded-part removal, or engagement and disengagement, making it possible to detachably combine the members. As a result, even when the heat treatment member is repeatedly loaded into the heat treating furnace, the members can be attached to and detached from each other.

(2) A heat treatment structure according to the present invention is a heat treatment structure repeatedly loaded into a heat treating furnace with a part to be heat-treated placed thereon or hooked thereto, comprising a heat treatment member that is, in part or in whole, the heat treatment member according to the above-described present invention.

According to this invention, (a) the heat treatment member constituting the heat treatment structure is detachably combined, in part or in whole, with the ST member and the CC member serving as the heat treatment members according to the above-described present invention, making it possible to simplify the structure of each member and achieve a reduction in man-hours and decrease manufacturing costs in comparison to the conventional technique. (b) The CC member is a carbon composite material that has heat resistance and does not readily thermally deform and thus, when the heat treatment structure is to be repeatedly loaded into a heat treating furnace for a prolonged period of time, a portion of the heat treatment member in which deformation, cracking, and the like are likely to occur and likely to affect the quality of the part to be heat-treated is used as the CC member, which is a separate member, allowing repeated use for a prolonged period of time. (c) The ST member and the CC member are separate members that can be combined and thus, by using a member having a complex structure as the low-cost ST member susceptible to deformation and the like but easy to process, it is possible to replace the ST member only with a spare part as needed and realize a reduction in total cost when used for a prolonged period of time.

### Effect of the Invention

According to the present invention, it is possible to provide a heat treatment member that, even when repeatedly loaded into a heat treating furnace with a part to be heat-treated placed thereon or hooked thereto in order to heat-treat the part to be heat-treated, suppresses the occurrence of deformation, cracking, and the like, allowing use for a prolonged period of time, and enables uniform and sufficient carburizing treatment of the part to be heat-treated, and a heat treatment structure obtained by combining the heat treatment members.

### BRIEF DESCRIPTION OF THE DRAWINGS

FIG. 1 is a perspective structural view illustrating an example of a heat treatment member and a heat treatment structure according to the present invention.

FIGS. 2A and 2B are examples of a support member (2A) and a hooking member (2B) serving as the heat treatment member illustrated in FIG. 1.

FIG. 3 is a perspective structural view illustrating another example of the heat treatment member and the heat treatment structure according to the present invention.

FIGS. 4A and 4B are examples of a support member (4A) and a hooking member (4B) serving as the heat treatment member illustrated in FIG. 3.

FIG. 5 is a perspective configuration view illustrating yet another example of the heat treatment member according to the present invention.

FIGS. 6A and 6B are perspective configuration views illustrating yet another example of the heat treatment member according to the present invention.

FIG. 7 is a perspective configuration view illustrating yet another example of the heat treatment member and the heat treatment structure according to the present invention.

FIGS. 8A and 8B are perspective configuration views illustrating yet another example of the heat treatment member and the heat treatment structure according to the present invention.

FIG. 9 is a perspective configuration view illustrating yet another example of the heat treatment member according to the present invention.

FIG. 10 is a perspective configuration view illustrating yet another example of the heat treatment member and the heat treatment structure according to the present invention.

FIG. 11 is a perspective configuration view illustrating an example of a base member.

FIGS. 12A and 12B are perspective configuration views illustrating an example of the heat treatment member and the heat treatment structure constituted by a steel material only.

FIG. 13 is a perspective configuration view illustrating another example of the heat treatment member constituted by a steel material only.

FIG. 14 is a perspective configuration view illustrating yet another example of the heat treatment member constituted by a steel material only.

FIGS. 15A and 15B are an example of a form in which the heat treatment member is screwed with a screw fastening member, FIG. 15A being a front view, and FIG. 15B being a plan view.

FIGS. 16A and 16B are an example of a form in which the heat treatment member is screwed with a screw fastening member and further welded, FIG. 16A being a front view, and FIG. 16B being a right side view.

FIGS. 17A and 17B are perspective views from above and below illustrating an example of a form in which the heat treatment member is welded by using a welding auxiliary member.

FIG. 18 is a perspective view illustrating another example of a form in which the heat treatment member is welded by using the welding auxiliary member.

FIG. 19 is a perspective view illustrating the heat treatment member in FIG. 18 from a bottom surface side.

FIG. 20 is a perspective view illustrating an example of a mounting member composed of a CC member.

FIG. 21 is a perspective view illustrating an example of a part hooking member composed of an ST member.

FIG. 22 is an explanatory view illustrating an example of a form in which the heat treatment member is engaged.

FIG. 23 is an explanatory view illustrating another example of a form in which a vibration-halting prevention member, composed of a CC member, and an ST member are engaged.

FIG. 24 is an explanatory view illustrating an example of the heat treatment structure having the structural form of FIG. 23.

FIG. 25 is a perspective view illustrating an example of the heat treatment structure in which a mounting member for mounting a part to be heat-treated and a stacking auxiliary member for stacking the mounting member are combined.

### EMBODIMENTS OF THE INVENTION

Hereinafter, a heat treatment member and a heat treatment structure according to the present invention will be described with reference to the drawings. It should be noted that the present invention is not limited to the embodiments described below.

### [Heat Treatment Member]

A heat treatment member 10 according to the present invention is a heat treatment member 10 constituting a heat treatment structure 60 repeatedly loaded into a heat treating furnace with a part to be heat-treated placed thereon or hooked thereto, as illustrated in FIG. 1 to FIG. 10. Then, the heat treatment member 10 has a special characteristic in which a member composed of a steel material or a Ni alloy material (hereinafter referred to as “ST member 1 (steel member)”) and a member composed of a carbon composite material (hereinafter referred to as “CC member 2”) are detachably combined. In the present invention, the ST member 1 is not particularly limited in terms of manufacturing method, but is preferably a member fabricated by a lost wax process, and the heat treatment member 10 is preferably a hooking member 10A for hooking the part to be heat-treated, a support member 10B for supporting the hooking member 10A, a mounting member 10C for mounting the part to be heat-treated, or a stacking auxiliary member 10D or a support column member 10E for stacking each of these members.

(a) This heat treatment member 10 is a member configured by combining the ST member 1 and the CC member 2 and not an integrated structure such as in the conventional technique, making it possible to simplify each member structure and achieve a reduction in man-hours and decrease manufacturing costs in comparison to the conventional technique. (b) The CC member 2 is a carbon composite material that has heat resistance and does not readily thermally deform and thus, when the combined heat treatment member 10 is to be repeatedly loaded into a heat treating furnace for a prolonged period of time, a portion in which deformation, cracking, and the like are likely to occur and likely to affect the quality of the parts to be heat-treated is used as the CC member 2, which is a separate member, allowing repeated use for a prolonged period of time. (c) The ST member 1 and the CC member 2 are separate members that can be combined and thus, by using a member having a complex structure as the low-cost ST member 1 susceptible to deformation and the like but easy to process, it is possible to replace the ST member 1 only with a spare part as needed.

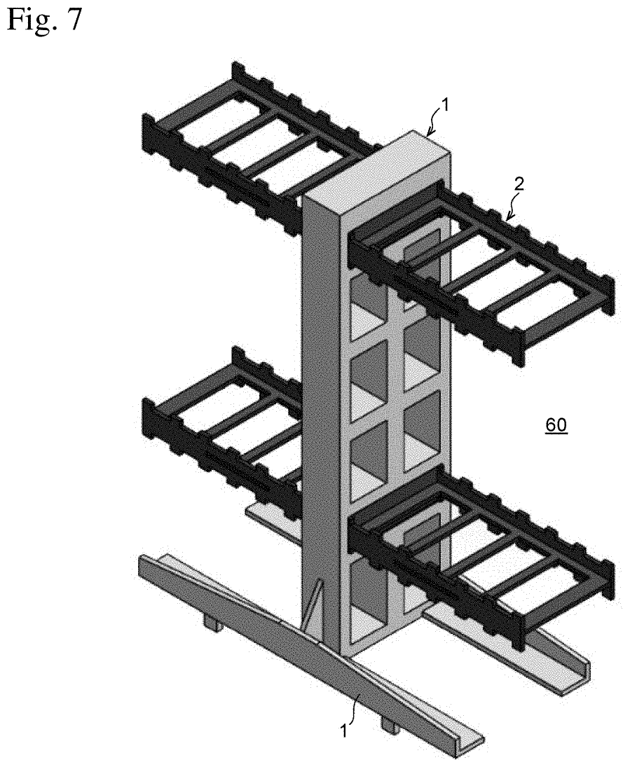

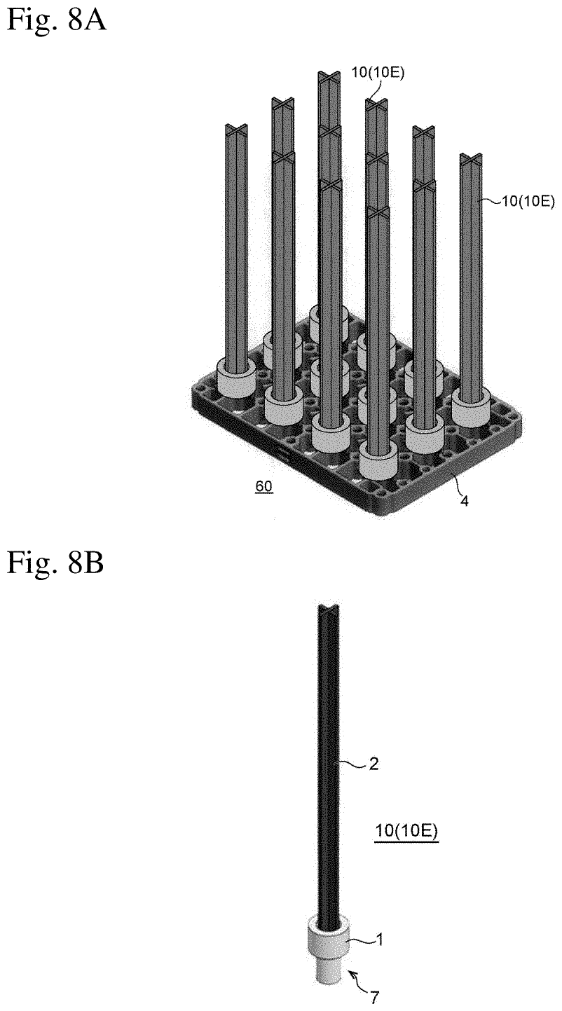

The heat treatment structure 60 according to the present invention is, as illustrated in FIG. 1, FIG. 3, FIG. 7, FIGS. 8A and 8B, and FIG. 10, for example, a heat treatment structure repeatedly loaded into a heat treating furnace with a part to be heat-treated placed thereon, hooked thereto, or the like, including a heat treatment member that is, in part or in whole, the heat treatment member 10 according to the above-described present invention.

Hereinafter, each of the components will be described.

### (Heat Treatment Member)

The heat treatment member 10 is a member repeatedly loaded into a heat treating furnace with a part to be heat-treated placed thereon, hooked thereto, or the like. This heat treatment member 10 may itself be the heat treatment structure 60 as illustrated in FIG. 7 and FIGS. 8A and 8B, for example, or may be the heat treatment structure 60 obtained by stacking or the like a plurality of the heat treatment members 10, as illustrated in FIG. 10. The heat treatment member 10 is not particularly limited in terms of structure, shape, size, or the like as long as the member is loaded into the heat treating furnace, and various member shapes can be used. For example, the structural forms illustrated in FIG. 1 to FIG. 10 or other structural forms can be used.

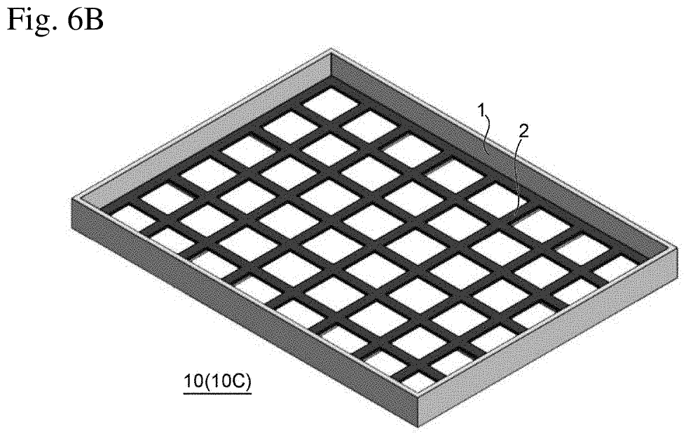

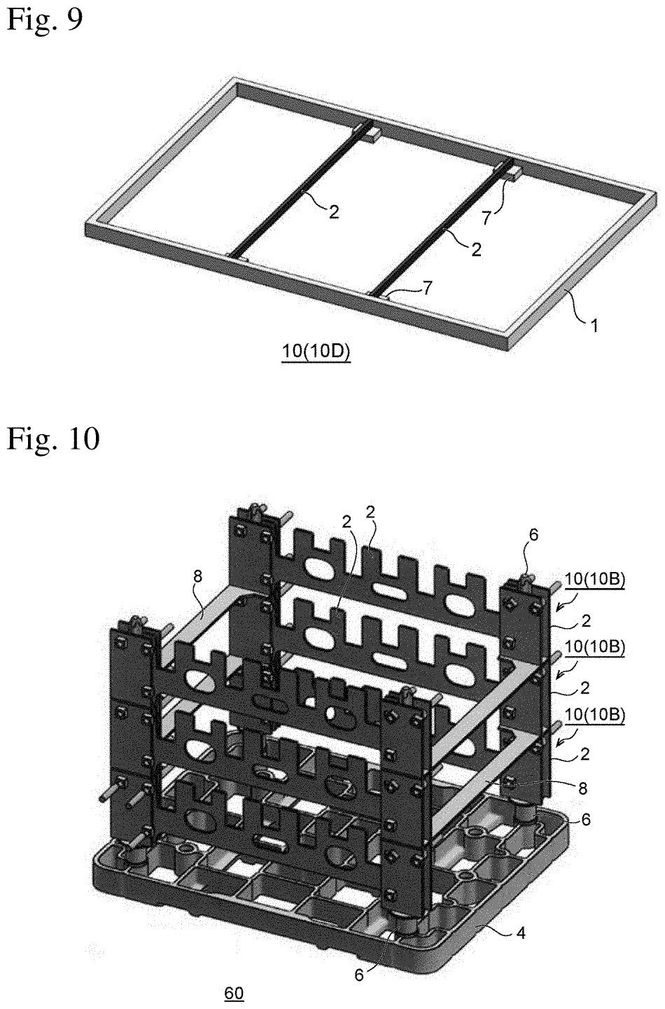

Examples of the heat treatment member 10 include the hooking member 10A for hooking the part to be heat-treated as illustrated in FIG. 1 to FIG. 5 and FIG. 7, the support member 10B for supporting the hooking member 10A as illustrated in FIG. 1 to FIG. 3 and FIGS. 4A and 4B, for example, the mounting member 10C for mounting the part to be heat-treated directly or via a dedicated member as illustrated in FIGS. 6A and 6B, a support column member 10E utilized as a hooking member, a corner member, or a center member as illustrated in FIG. 8B, the stacking auxiliary member 10D for stacking the heat treatment members 10A to 10C as illustrated in FIG. 9, the heat treatment structure 60 obtained by stacking or the like a plurality of heat treatment members 10 as illustrated in FIG. 10, and the like. Further, a rod-shaped member (support column member 10E) illustrated in FIGS. 8A and 8B may be used as a hooking member for hooking the part to be heat-treated.

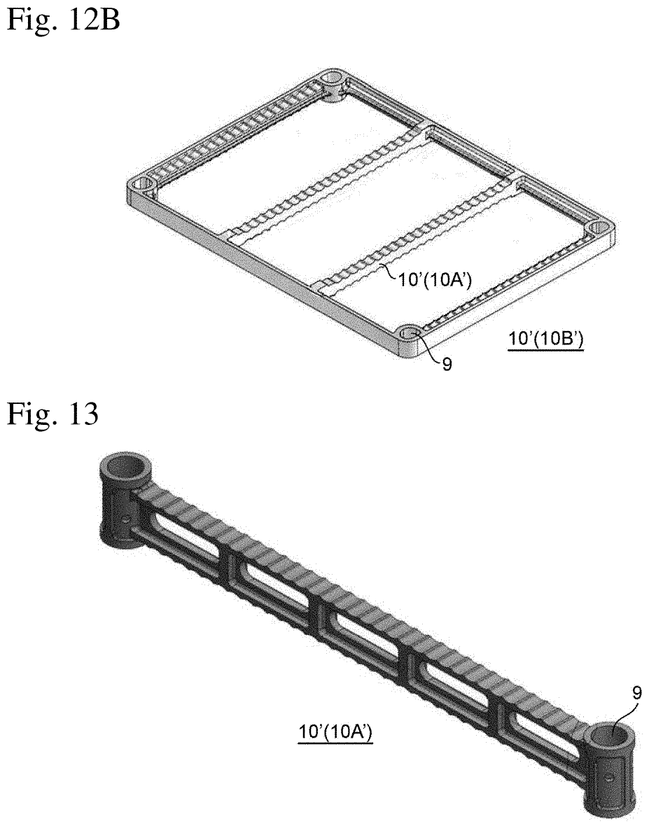

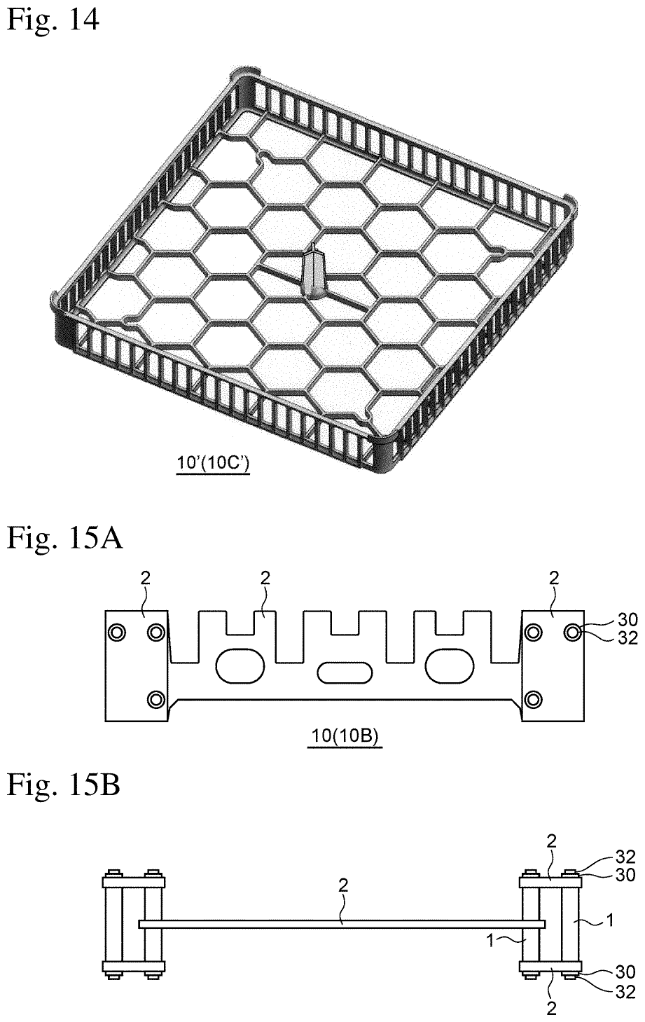

It should be noted that the hooking member 10A may be a member for hooking a plurality of the parts to be heat-treated at the same time, or may be a member for hooking an individual part to be heat-treated. Further, examples of the stacking auxiliary member 10D include a support column provided at a corner, a center, or the like, in a case in which the mounting member 10C or the like having a tray shape is vertically stacked, a member sandwiched therebetween (refer to reference sign 10D in FIG. 9, reference sign 10D′ in FIGS. 12A and 12B, and reference sign 10D in FIG. 25, for example), or the like. Furthermore, the support column member 10E is not necessarily provided in position such as a corner or a center, and examples thereof include, in a case in which the tray-shaped mounting member 10C or the like is vertically stacked, a member that passes through a hole 9 provided thereto (refer to FIGS. 12A and 12B and FIG. 13) or the like. The heat treatment structure constituted by these heat treatment members 10A to 10E can be saved in weight as a whole and used for a prolonged period of time while replacing the ST member 1 as needed.

### (ST Member and CC Member)

The ST member 1 is a member composed of a steel material or a Ni alloy material. This ST member 1, while not particularly limited in material as long as a steel material or a Ni alloy and further not particularly limited in manufacturing method as well, may be composed of a steel material or a Ni alloy that can be preferably manufactured by the lost wax process. Specific examples include a nickel-containing steel material such as austenitic stainless steel and a heat-resistant cast steel, high-Ni alloys such as Inconel, and the like. These steel materials or Ni alloys are excellent in high-temperature strength and high-temperature oxidation resistance, and thus can be preferably adopted as members repeatedly loaded into a heat treating furnace even though not to the extent of the CC member 2. It should be noted that this ST member 1 may contain various other elements as long as within a range that the effect of the present invention is not impaired, and the fabricated ST member 1 may be a member hardened or surface-modified.

The ST member 1 is not limited to a member fabricated by the lost wax process, but is particularly preferably a member fabricated by the lost wax process and is excellent in terms of cost as well. The lost wax process has the advantage that fabrication can be performed with high accuracy at low cost even with complex shapes, and a decrease in the cost of complex structures can be realized. As a result, there is the advantage that, even if not insusceptible to deformation over a prolonged period of time due to heat treatment, the member can be immediately replaced with other spare parts. The lost wax process is a method in which a prototype is formed of wax, a periphery of the prototype is covered and solidified with casting sand or plaster, the internal wax is melted and removed by heating, and a molten steel material is poured into the formed cavity to obtain a casting having the same shape as the prototype.

The CC member 2 is a member composed of a carbon composite material. A carbon composite material, in comparison to a metal material, has heat resistance and is less susceptible to thermal expansion and thermal deformation. The CC member 2 fabricated using a carbon composite material, even when the heat treatment member 10 and the heat treatment structure 60 are repeatedly loaded into a heat treating furnace for a prolonged period of time, is less susceptible to deformation, cracking, and the like, allowing repeated use for a prolonged period of time. This carbon composite material has enough heat resistance for use even at about 2200° C. Therefore, like the carburizing treatment, the nitriding treatment, and the like of the part to be heat-treated, there is no adverse effect due to thermal deformation or the like caused by heat treatment temperatures of approximately 950° C. to approximately 1200° C. Pricewise, a carbon composite material is expensive in comparison to a steel material, and thus preferably the CC member 2 is fabricated using a carbon composite material after simplifying structures thereof to the extent possible. The CC member 2 fabricated using a carbon composite material can be used for a prolonged period of time. As a result, in terms of total cost, even if the heat treatment member 10 is fabricated by combining the CC member 2 composed of an expensive carbon composite material, the cost can be significantly reduced.

As the carbon composite material, various materials can be used. A carbon material having high strength and high elasticity and reinforced with carbon fiber is preferable. In particular, preferable examples include a carbon matrix such as graphite in which carbon fibers are combined as reinforced fibers. As the carbon fibers, those having a long fiber length are preferable to those having a short fiber length, and those having a regular arrangement in vertical and horizontal directions are preferable to those randomly arranged in the matrix without directionality. With the carbon fibers combined in the matrix in such a mode, the material can be preferably utilized as a carbon composite material having high tensile strength and high elasticity. It should be noted that, while not particularly limited, a bending strength is approximately 140 to 160 MPa, a tensile strength is approximately 250 MPa, a bulk specific gravity is approximately 1.6 g/cm³, a compressive strength is approximately 90 MPa, a bending elastic modulus is approximately 60 GPa, and a tensile elastic modulus is approximately 80 GPa, for example. Further, a thermal expansion coefficient is approximately 0.2 to 0.4 (//)×10⁻⁶/K and approximately 5 to 9 (⊥)×10⁻⁶/K, and a thermal conductivity is approximately 27 (//) W/m·K and approximately 4 (⊥) W⁶/m·K, but are not limited thereto. The CC member 2 may be a member fabricated using the same carbon composite material or may be a member fabricated using different carbon composite materials. Whether the materials are the same or different can be selected as desired in consideration of ease of manufacture, material cost, strength required for each, and the like.

Specifically, as a commercially available carbon composite material, for example, the Sigrabond series by SGL Carbon Japan Co., Ltd., the CCM190 series by Nippon Carbon Co., Ltd., or the like can be obtained as desired, and selected as desired for use. Further, a material obtained by impregnating a carbon composite material with silicon (Si) can also be selected as desired for use. Furthermore, these carbon composite materials are marketed as bolts and nuts as well, and can be used and processed. It should be noted that, while the processing method of these carbon composite materials is not particularly limited, the materials can be processed into a predetermined structural shape by processing means such as general cutting, grinding, or water jet cutting.

In the heat treatment member 10, the ST member 1 and the CC member 2 are detachably combined. The CC member 2 is a carbon composite material that has heat resistance and does not readily thermally deform and thus, when the heat treatment member 10 obtained by combining the CC member 2 with the ST member 1 is to be repeatedly loaded into a heat treating furnace for a prolonged period of time, a portion in which deformation, cracking, and the like are likely to occur and likely to affect the quality of the part to be heat-treated is used as the CC member 2, which is a separate member from the ST member 1, allowing repeated use for a prolonged period of time. Further, the ST member 1 and the CC member 2 are separate members that can be combined and thus, by using a member having a complex structure as the low-cost ST member 1 susceptible to deformation and the like but easy to process, it is possible to replace the ST member 1 only with a spare part as needed. This way, it is possible to simplify each member structure and achieve a reduction in man-hours and decrease manufacturing costs in comparison to the conventional technique.

### (Heat Treatment Structure)

The heat treatment structure 60, as illustrated in FIG. 1, FIG. 3, FIG. 7, FIGS. 8A and 8B, and FIG. 10, for example, is a heat treatment structure repeatedly loaded into a heat treating furnace with a part to be heat-treated placed thereon, hooked thereto, or the like, including a heat treatment member constituting the heat treatment structure that is, in part or in whole, the heat treatment member 10 according to the above-described present invention. This heat treatment structure 60 may, in whole, be the heat treatment member 10 as illustrated in FIG. 7, or may, in part, be the heat treatment member 10, as illustrated in FIGS. 8A and 8B and FIG. 10. It should be noted that the heat treatment member 10 illustrated in FIG. 1 to FIG. 5, FIGS. 6A and 6B, and FIG. 9 may also be a heat treatment structure placed on a base member 4 as is as in FIG. 1, FIG. 3, FIG. 7, and FIGS. 8A and 8B, may be a member stacked and constituting the heat treatment structure 60 in the same manner as in FIG. 10, and is not particularly limited.

The heat treatment structure 60 obtained by stacking the heat treatment member 10 can be obtained by stacking the heat treatment member 10B, as illustrated in FIG. 10, for example. The stacking can be obtained by first using the base member 4 as the member in the lowermost stage, and then sequentially placing the heat treatment members 10B thereon.

### (Base Member)

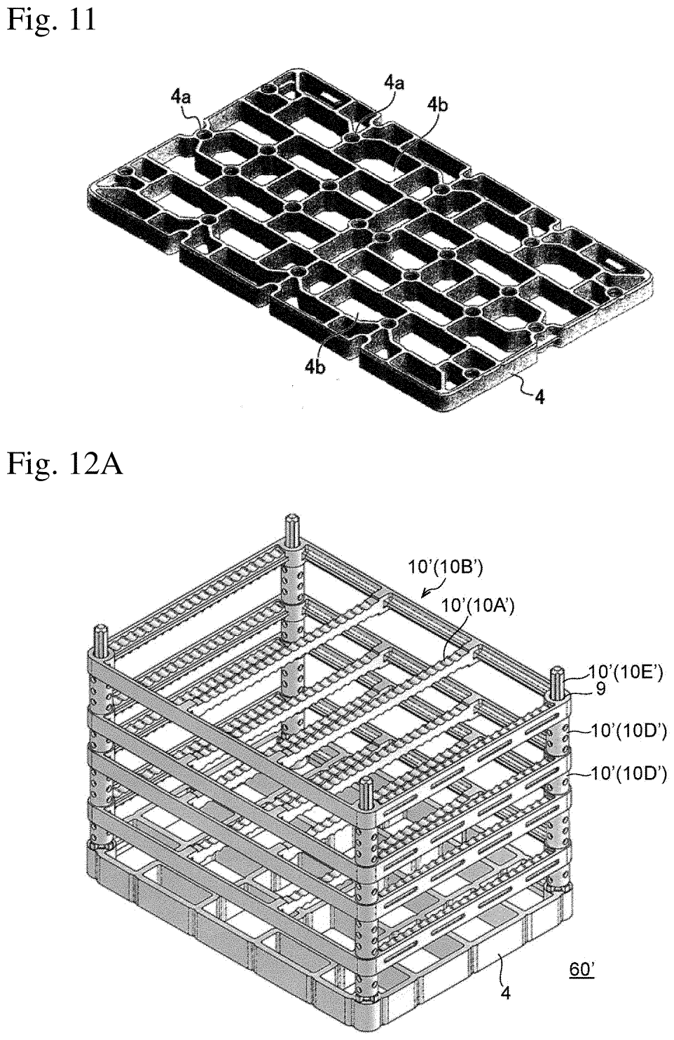

As illustrated in FIG. 1, FIG. 3, FIGS. 8A and 8B, and FIG. 10, the base member 4 is used as a member repeatedly loaded into a heat treating furnace with the heat treatment member 10 placed thereon. The base member 4 can prevent wear of a lower surface portion of the heat treatment member that occurs during loading in and out of the heat treating furnace. The base member 4 is not particularly limited in terms of material, but is preferably constituted by a steel material or a Ni alloy material and preferably fabricated by a lost wax process in particular. The structural form of the base member 4 includes reinforcement holes 4a and space parts 4b, as illustrated in FIG. 11. The reinforcement holes 4a, by being provided as circular holes to intersecting parts of the frame, are provided so as to increase a rigidity or the like of the entire base member. The space parts 4b are provided as desired as needed in order to save the weight.

### EMBODIMENTS

Hereinafter, embodiments will be described, but the present invention is not limited to the illustrated embodiments as long as the technical features thereof are included.

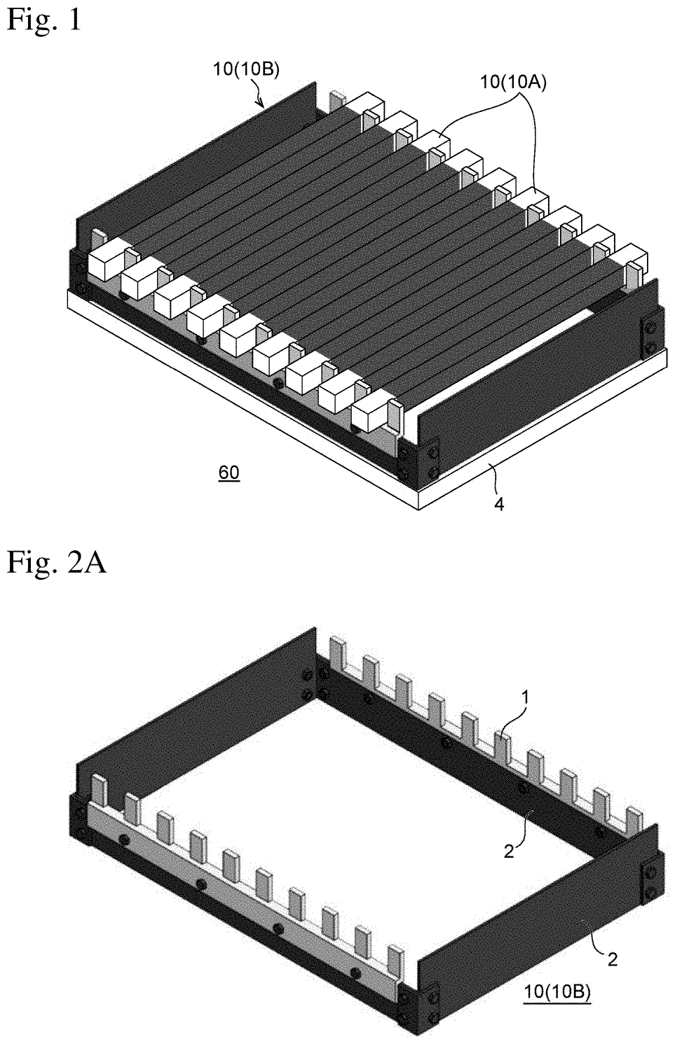

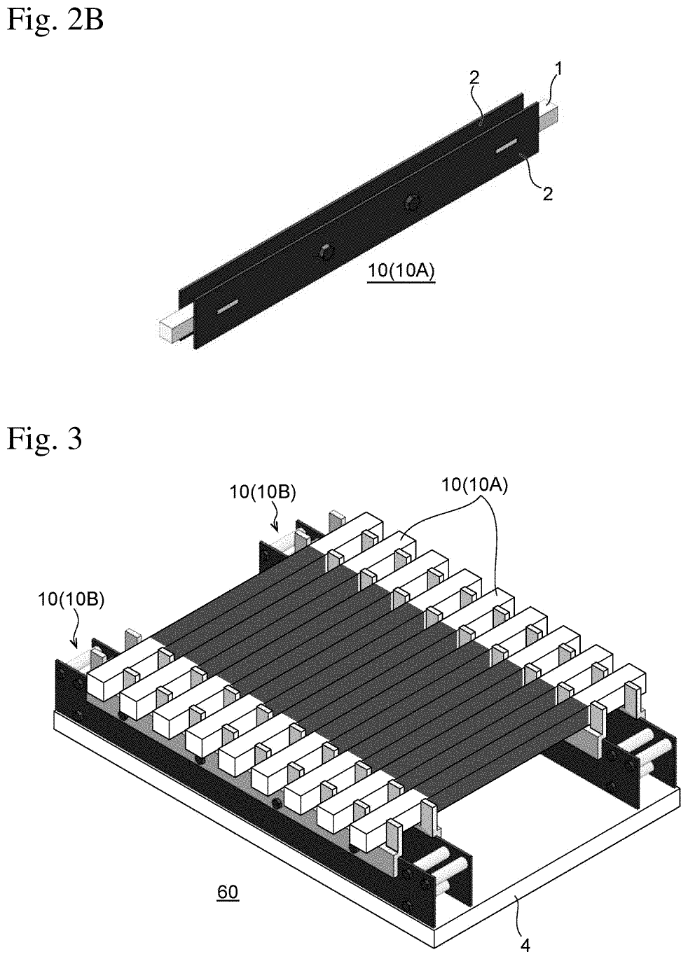

### (Embodiment Illustrated in FIG. 1 and FIGS. 2A and 2B)

The heat treatment structure 60 illustrated in FIG. 1 includes, as the heat treatment members 10A, 10B, the hooking member 10A for hooking the part to be heat-treated and the support member 10B for supporting the hooking member 10A. The hooking member 10A is configured by detachably combining the ST member 1 having a rod shape and the CC member 2 that covers the ST member 1, as illustrated in FIG. 2B. The combination form is not particularly limited. The support member 10B is configured by detachably combining the CC members 2 having a rectangular frame shape and the comb-shaped ST member 1 provided on two opposing sides of the frame and sequentially aligning and supporting the hooking members 10A one by one, as illustrated in FIG. 2A. It should be noted that the hooking member 10A illustrated in FIG. 1 has a form in which the ST member 1 having a square-bar shape is covered with the detachable CC member 2, but like the hooking member 10A in FIG. 2B, may be a member detachably provided with two CC members 2 having a plate shape on opposite surfaces of the square bar-shaped ST member 1.

The hooking member 10A is a member having a rod shape and configured by screwing or the like with a screw fastening member and detachably combining the square bar-shaped ST member 1 and the plate-shaped CC members 2 mounted on the opposite surfaces of the ST member 1, as illustrated in FIG. 2B. This hooking member 10A is combined with the CC member 2 and thus suppresses the occurrence of deformation, cracking, and the like, even if repeatedly heat-treated in comparison to a member constituted by the ST member 1 only, making use possible for a prolonged period of time. At both ends of the hooking member 10A, the ST member 1 having higher wear resistance and strength than the CC member 2 is exposed by a certain length. Therefore, even if the exposed portions at both ends of the hooking member 10A are hooked onto the comb-shaped ST member 1, both are less susceptible to wear and have strength as well, making stable hanging possible. While a cylindrical portion of a part to be heat-treated having a cylindrical shape is passed through this hooking member 10A and hooked onto the support member 10B, deformation or the like based on the weight is unlikely to occur due to the rod-shaped ST member 1 having strength. It should be noted that, in a case in which the ST member 1 is deformed or the like due to repeated use, by replacement of the ST member 1 only, it is further possible to continue use for a prolonged period of time and realize a decrease in cost.

The support member 10B is configured by screwing or the like with screw fastening members and detachably combining the CC members 2 formed into a rectangular frame shape and the comb-shaped ST members 1 provided on two opposing sides of the frame and sequentially aligning and supporting the hooking members 10A one by one, as illustrated in FIG. 2A. This support member 10B is formed into a rectangular shape by screwing or the like the CC members 2 with screw fastening members, and thus suppresses the occurrence of deformation, cracking, and the like, even if repeatedly heat-treated in comparison to a member constituted by the ST member 1 only, making use possible for a prolonged period of time. The ST members 1 having higher wear resistance and strength than the CC member 2 are fixed to the sides of the support member 10B facing each other by being screwed with the screw fastening members or the like. Therefore, even if the rod-shaped hooking member 10A described above is hooked onto the ST members 1, both are less susceptible to wear and have strength as well, making stable hanging possible. It should be noted that, in a case in which the ST member 1 is deformed or the like due to repeated use, by replacement of the ST member 1 only, it is further possible to continue use for a prolonged period of time and realize a decrease in cost.

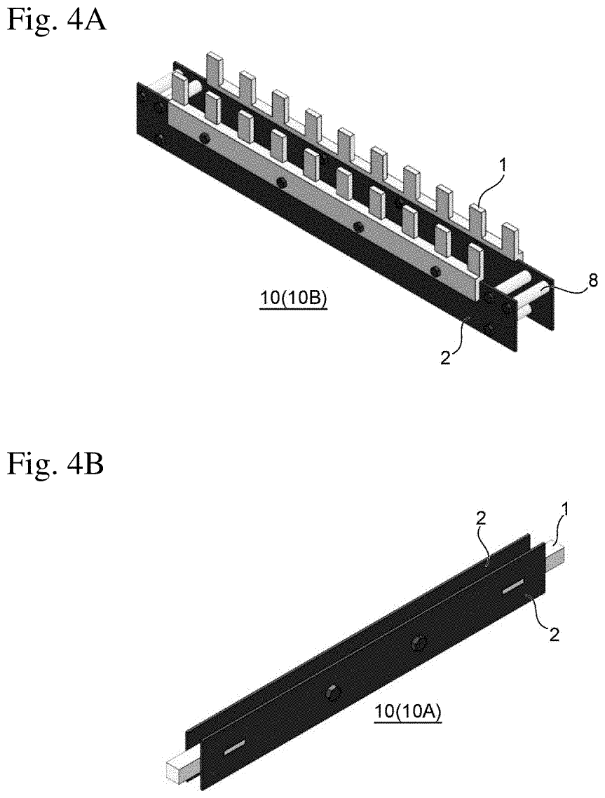

### (Embodiment Illustrated in FIG. 3 and FIGS. 4A and 4B)

The heat treatment structure 60 illustrated in FIG. 3 includes, as the heat treatment members 10A, 10B, the hooking member 10A for hooking the part to be heat-treated and two of the support members 10B for respectively supporting both end portions of the hooking member 10A, as described above. The hooking member 10A is, as in FIG. 2B, configured by detachably combining the rod-shaped ST member 1 and the CC member 2 that covers the ST member 1, as illustrated in FIG. 4B. The combination form is not particularly limited. The support member 10B is configured by detachably combining the two plate-shaped CC members 2 coupled by a coupling member 8, and the comb-shaped ST members 1 respectively provided to the CC member 2 and sequentially aligning and supporting the hooking members 10A one by one, as illustrated in FIG. 4A.

The hooking member 10A is the same as that in FIG. 2B described above, and thus description thereof will be omitted here. In this case as well, the hooking member 10A illustrated in FIG. 3 has a form in which the square bar-shaped ST member 1 is covered with the detachable CC member 2, but like the hooking member 10A in FIG. 4B, may be a member detachably provided with two plate-shaped CC members 2 on opposite surfaces of the square bar-shaped ST member 1.

The support member 10B is configured by screwing or the like with screw fastening members and detachably combining the two plate-shaped CC members 2 coupled by the coupling member 8, and the comb-shaped ST members 1 respectively provided to the CC member 2 and sequentially aligning and supporting the hooking members 10A one by one, as illustrated in FIG. 4A. This support member 10B is formed by connecting the two plate-shaped CC members 2 with the coupling member 8, and thus is compact in comparison to the member having rectangular form in FIG. 2A. Therefore, this support member 10B can be disposed facing the base member 4 as illustrated in FIG. 3. Further, the disposed interval can also be adjusted as desired, and thus the hooking member 10A having a short length may be used. The ST members 1 having higher wear resistance and strength than the CC member 2 are fixed to the two CC members 2 constituting the support member 10B by being screwed with screw fastening members or the like. Therefore, even if the rod-shaped hooking member 10A is hooked onto the ST members 1, both are less susceptible to wear and have strength as well, making stable hanging possible. It should be noted that, in a case in which the ST member 1 is deformed or the like due to repeated use, by replacement of the ST member 1 only, it is further possible to continue use for a prolonged period of time and realize a decrease in cost.

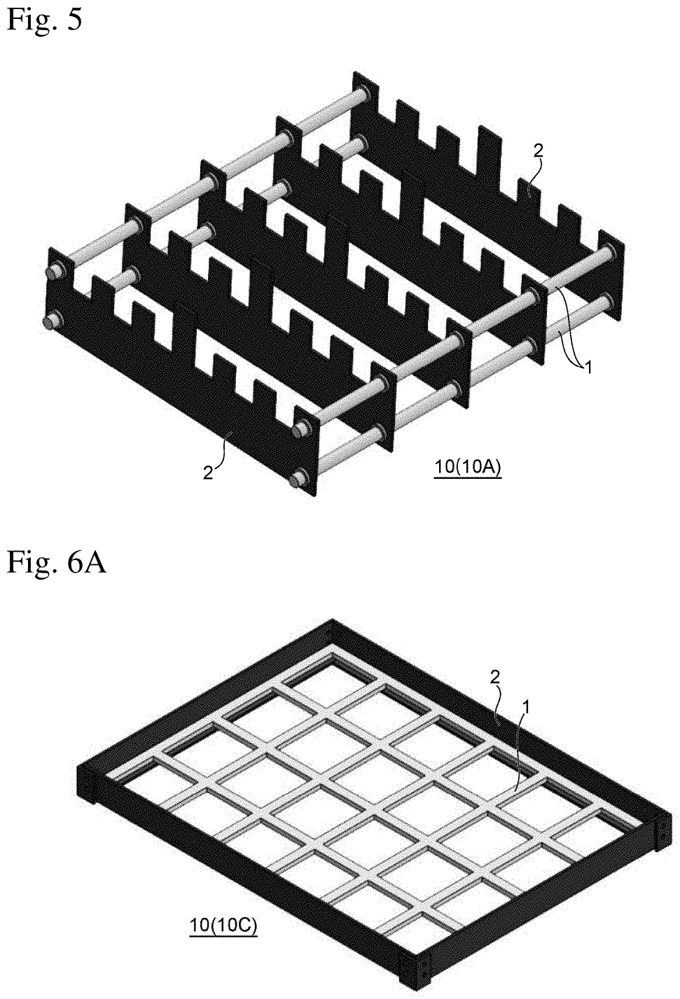

### (Embodiment Illustrated in FIG. 5)

The heat treatment member 10 illustrated in FIG. 5 is configured by combining a plurality of the plate-shaped CC members 2 aligned at a predetermined interval to hook the part to be heat-treated, and the ST members 1 coupling the plurality of CC members 2. This heat treatment member 10 functions as the hooking member 10A for hooking the part to be heat-treated. The plate-shaped CC member 2 is provided with convex portions in a comb shape for hooking the part to be heat-treated. Heights of the convex portions may be all constant or may be different as illustrated in FIG. 5. The CC members 2 may be disposed at a certain interval or may be disposed at different intervals. Two of the rod-shaped ST members 1 functioning as coupling members are passed through holes at both end portions of the plate-shaped CC member 2, and a plurality of the plate-shaped CC members 2 are coupled by screws or the like. It should be noted that various changes are possible as long as the member is configured in such a mode. This heat treatment member 10 is constituted by the CC member 2 having a plate shape and a simple structure, and thus can be used as a low-cost member.

### (Embodiment Illustrated in FIGS. 6A and 6B)

The heat treatment member 10 illustrated in FIGS. 6A and 6B is the mounting member 10C for mounting the part to be heat-treated directly or via a dedicated member. As illustrated in FIGS. 6A and 6B, this mounting member 10C includes a grid-shaped tray part on which the part to be heat-treated can be mounted, and a frame part provided on a peripheral edge of the tray part. The grid form of the tray part may be a square, a triangle, or a hexagon. The mounting member 10C in FIG. 6A is a member constituted by the tray part composed of the ST member 1 and the frame part composed of the CC member 2, and the mounting member 10C in FIG. 6B is a member constituted by the tray part composed of the CC member 2 and the frame part composed of the ST member 1. Use of the form of FIG. 6A or the form of FIG. 6B can be selected taking into consideration the wear resistance and strength of the ST member 1, the heat resistance and deformation resistance of the CC member 2, cost, and the like.

It should be noted that the “dedicated member” on which the part to be heat-treated is placed is a dedicated member for placing a specific part to be heat-treated, and is placed on the tray part with the part to be heat-treated placed thereon. Such a dedicated member is often used in the case of a heat treatment member having a special shape and has often a complex shape, and thus is preferably fabricated by a lost wax process that allows easy fabrication of a structure having a complex shape, and is preferably a member formed of the same steel material or Ni alloy material as the ST member 1, for example. That is, this “dedicated member” can be referred to as a member, among the heat treatment members, detachably mounted to another member (including another heat treatment member), and is preferably a member composed of the same steel material or Ni alloy material as the ST member 1. Although susceptible to deformation and the like in comparison to the CC member, the dedicated member formed of the ST member 1 has favorable wear resistance, high strength, and low cost, making replacement with a spare part having high wear resistance at low cost in accordance with the type of the part to be heat-treated possible, and is thus convenient.

### (Embodiment Illustrated in FIG. 7)

The heat treatment structure 60 illustrated in FIG. 7 is a scaffolding-shaped structure, and is constituted by two upper and lower CC members 2 having a ladder shape and the ST member 1 for attaching the ladder-shaped CC members 2 to the scaffolding form. The ladder-shaped CC member 2 is constituted by a ladder-shaped tray part for hooking the part to be heat-treated and plate-shaped frame parts provided to opposing long sides of the tray part. The scaffolding-shaped structure configured in this way is a stacked structure itself, and thus can be referred to as the heat treatment structure 60. The ladder-shaped CC member 2 suppresses the occurrence of deformation, cracking, and the like, even if repeatedly heat-treated, making use possible for a prolonged period of time. The scaffolding-shaped ST member 1 can be fabricated by a low-cost method such as a lost wax process even if complex in shape and, when thermal deformation occurs, the scaffolding-shaped ST member 1 only can be easily replaced. On the other hand, the CC member 2 can be used repeatedly without being thermally deformed, and thus a decrease in cost can be realized.

### (Embodiment Illustrated in FIGS. 8A and 8B)

The heat treatment structure 60 illustrated in FIGS. 8A and 8B is configured by inserting one end of each heat treatment member 10E having a rod shape into a plurality of holes provided in the base member 4 or a tray member. The rod-shaped heat treatment member 10E is utilized as a hooking member for hooking a cylindrical part. This rod-shaped heat treatment member 10E is configured by engaging by insertion or the like and detachably combining a detachable member 7 composed of the ST member 1 to be detachably mounted to the base member 4 or a tray member, and a rod-shaped member composed of the CC member 2 mounted to the detachable member 7. The detachable member 7 composed of the ST member 1 is a portion to which a load is applied, and thus is preferably constituted by the ST member 1 having higher wear resistance and strength than the CC member 2. Further, the ST member 1 has a lower cost than the CC member 2, and thus can also be easily replaced with a spare part. On the other hand, the CC member 2 does not readily deform by heat, making it possible to prevent the parts to be heat-treated from coming into contact with each other due to deformation.

### (Embodiment Illustrated in FIG. 9)

The heat treatment member 10 illustrated in FIG. 9 is the stacking auxiliary member 10D provided as desired between members in order to stack the members 10A to 10C already described. This stacking auxiliary member 10D is configured by detachably engaging and combining a frame body composed of the ST member 1 and a rod-shaped member composed of the CC member 2 hung in a ladder shape at a plurality of locations of the frame body. While the frame body composed of the ST member 1 is susceptible to deformation during heat treatment, the rod-shaped member composed of the CC member 2 less susceptible to thermal deformation is hung on the frame body, making it possible to suppress deformation of the frame body and continue use for a prolonged period of time. With the stacking auxiliary member 10D provided as desired between members, the interval between the members to be stacked can be adjusted in accordance with the size of the part to be heat-treated.

### (Embodiment Illustrated in FIG. 10)

The heat treatment structure 60 illustrated in FIG. 10 is obtained by stacking the heat treatment members 10B. The specific form has substantially the same configuration as the heat treatment structure 60 in FIG. 3, and the same function. It should be noted that, in FIG. 10, the hooking member hung between the CC members 2 facing each other (corresponding to the hooking member 10A hung between the support members 10B in FIG. 3) is not illustrated for the sake of convenience, but in reality a hooking member is provided between the CC members 2 constituting the support member 10B. Reference sign 8 denotes the coupling member for coupling the support members facing each other during stacking, reference sign 4 denotes the base member 4, and reference sign 6 denotes a support column member 6 having a rod shape and passing through the stacked heat treatment members 10B. This rod-shaped support column member 6 can be constituted by a steel material or the like, is not necessarily provided in position such as a corner or a center, and, in a case in which the heat treatment members 10B are vertically stacked, can be used as a member that passes through a penetrating part provided thereto. The heat treatment structure 60 constituted by these members can be saved in weight as a whole and used for a prolonged period of time while replacing the ST member 1 as needed.

### (Detachable Means)

In the heat treatment member 10 according to the present invention, the ST member 1 and the CC member 2 are attached and detached by means selected from screw fastening and unfastening using a screw fastening member (bolt and nut), welding and welded-part removal using a welding auxiliary member, and engagement and disengagement of the ST member 1 and the CC member 2. This way, the members can be detachably combined and, as a result, in a case in which the heat treatment member 10 is repeatedly loaded into a heat treating furnace and deformation or the like occurs in the ST member 1, can be easily attached and detached. Then, the CC member 2 can be continuously reutilized, resulting in an excellent cost advantage.

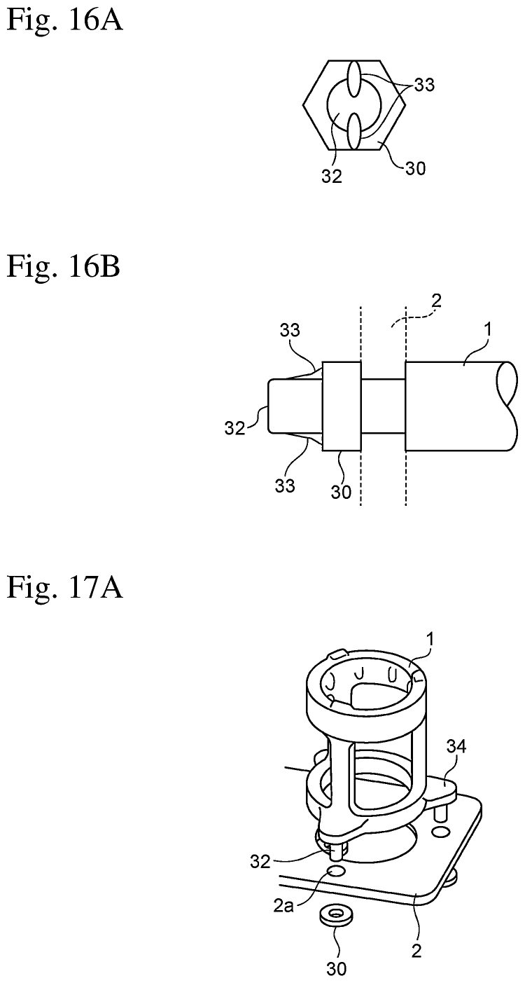

Examples of the form of “screw fastening and unfastening using a screw fastening member” include a general screwing form such as illustrated in FIG. 1 to FIG. 5 and FIG. 10 already described and a screwing form such as illustrated in FIGS. 15A and 15B and FIGS. 16A and 16B. The screwing form is a form in which fastening and screwing is performed using a screw fastening member, and unfastening is performed by loosening the fastening. While preferably the screw fastening member is prepared as a separate member from the ST member 1 and the CC member 2, and the bolts and nuts are formed of a steel material or a Ni alloy having the same high heat resistance as the ST member 1, it is also possible to integrally process and provide a screw fastening part (bolt and nut) to a portion of the easy-to-process ST member 1. It should be noted that a washer is preferably used together with the screw fastening member as in general screw fastening. This washer is also preferably formed of a steel material or a Ni alloy material having high heat resistance.

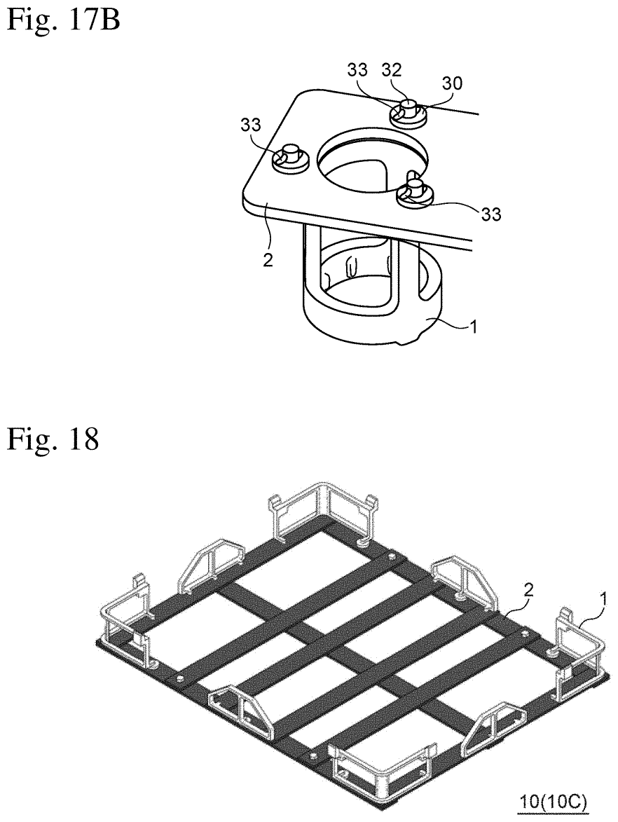

A more detailed explanation will now be provided with reference to FIGS. 15A and 15B and FIGS. 16A and 16B. The heat treatment member 10 illustrated in FIGS. 15A and 15B is an example of the support member 10B constituting the heat treatment structure 60 illustrated in FIG. 10. In the support member 10B illustrated in FIG. 10, both the comb-shaped CC member 2 that supports the hooking member (not illustrated) and the plate-shaped holding member that holds the CC member 2 on both sides are constituted by the ST member 1. In contrast, in the support member 10B illustrated in FIGS. 15A and 15B, the holding members on both sides are constituted by the CC member 2 instead of the ST member 1, thereby suppressing thermal deformation of the holding members on both sides and allowing use for a prolonged period of time. In the form illustrated in FIGS. 15A and 15B, the holding member composed of the CC member 2 is constituted by two plates composed of the CC member 2 and three pipe-shaped ST members 1 that maintain the plates at a certain interval. Male screws are formed on a projecting part 32 at both ends of the three ST members 1 having a pipe shape in the longitudinal direction. An engaging hole (not illustrated; refer to reference sign 2a in FIGS. 17A and 17B) of the plate-shaped CC member 2 is inserted into the projecting part 32 and, as necessary, screwed using a nut (screw fastening member 30) with a washer interposed therebetween.

The form of “welding and welded-part removal using a welding auxiliary member” is a detachable fixed form such as illustrated in FIGS. 16A and 16B, FIGS. 17A and 17B, FIG. 18, and FIG. 19, and is a form in which the ST member 1 and a welding auxiliary member 30 are welded and fixed by a welded part 33, and the ST member 1 is detached by removing the welded part 33 welded. The welding auxiliary member 30 is a member welded at the ST member 1 in order to fix the ST member 1 to the CC member 2. The welded part 33 can be removed by any one or two or more means among disconnecting, cutting, grinding, polishing, or the like the welded part 33 and, with the removal of the welded part 33, the welding auxiliary member 30 is detached. The detached ST member 1 is replaced with a new ST member 1, but the CC member 2 is continuously reutilized.

In the attachment and detachment form of welding and welding removal, welding may be performed with the members screwed by the screwing form illustrated in FIGS. 15A and 15B. Specifically, as illustrated in FIGS. 16A and 16B, it is possible to screw the members with the screw fastening member 30 and further weld the screw fastening member 30 and the projecting part 32 of the ST member 1. The ST member 1 and the screw fastening member 30 are fixed by the welded part 33 formed by welding, and the ST member 1 and the CC member 2 are fixed. It should be noted that the screw fastening member 30 at this time functions as a welding auxiliary member as well. In the example of FIGS. 16A and 16B, the welding locations are two locations facing each other around the projecting part 32, but may be one location, the entire circumference, or positions not facing each other, and are not particularly limited.

FIGS. 17A and 17B illustrate a form in which the ST member 1 and the CC member 2 constituting the heat treatment member are welded by using the welding auxiliary member 30, and illustrate a part hooking member composed of the ST member 1 and a mounting member composed of the CC member 2 for mounting the part hooking member. The mounting member composed of the CC member 2 is provided with an engaging hole 2a that engages with the projecting part 32 of the ST member 1. In the example of FIGS. 17A and 17B, three engaging holes 2a corresponding to the number of projecting parts 32 of the ST member 1 are provided, but the number is not particularly limited.

On the other hand, the ST member 1 is not limited to the form illustrated in FIGS. 17A and 17B as long as provided with the projecting part 32 that engages with the engaging hole 2a of the CC member 2. In particular, the projecting part 32 is not necessarily a circular form illustrated in FIGS. 17A and 17B, and may have various projecting forms such as a quadrangle, a triangle, and an ellipse. Further, the number of the projecting parts 32 is also not limited to the three illustrated in FIGS. 17A and 17B, as long as engagement with the engaging hole 2a and other structural portions of the corresponding CC member 2 is possible, and may be one, two, four, or the like. The ST member 1 and the CC member 2 can be formed and engaged with each other in sizes that take into consideration thermal expansion during heat treatment, the welding auxiliary member 30 having a doughnut shape can be subsequently inserted onto the projecting part 32 protruding from the engaging hole 2a, and the welding auxiliary member 30 and the projecting part 32 of the ST member 1 can be subsequently welded. The ST member 1 and the welding auxiliary member 30 are fixed by the welded part 33 formed by welding, and the ST member 1 and the CC member 2 are fixed. It should be noted that the mounting member composed of the ST member 1 is a member having a cylindrical form on which the part to be heat-treated can be placed or hooked, but is not particularly limited.

FIG. 18 and FIG. 19 are another form in which the ST member 1 and the CC member 2 are welded by using the welding auxiliary member 30. Here, the ST member 1 is the ST member 1 having a function of stacking the tray-shaped mounting member 10C on an outer edge of the tray-shaped mounting member 10C, and is a frame member fabricated at a same height on the outer edge of the mounting member 10C. The ST member 1 composed of the frame member is provided with the projecting part 32. As described in FIGS. 17A and 17B, the projecting part 32 can be inserted into the engaging hole 2a provided on the outer edge of the CC member 2, the ST member 1 and the CC member 2 can be engaged with each other, the projecting part 32 protruding from the engaging hole 2a can be subsequently inserted into the doughnut-shaped welding auxiliary member 30, and the welding auxiliary member 30 and the projecting part 32 of the ST member 1 can be subsequently welded. The ST member 1 and the welding auxiliary member 30 are fixed by the welded part 33 formed by welding, and the ST member 1 and the CC member 2 are fixed.

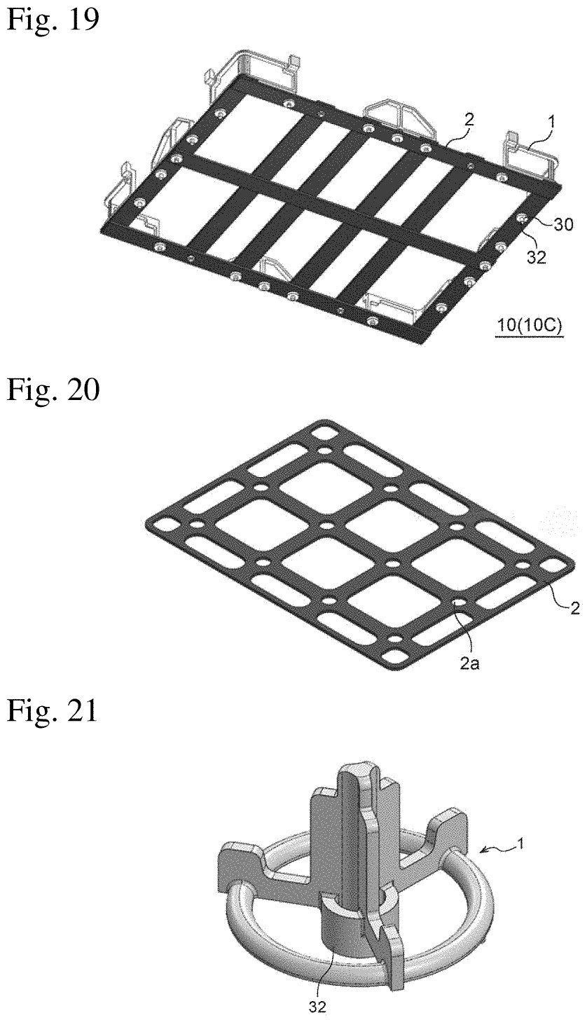

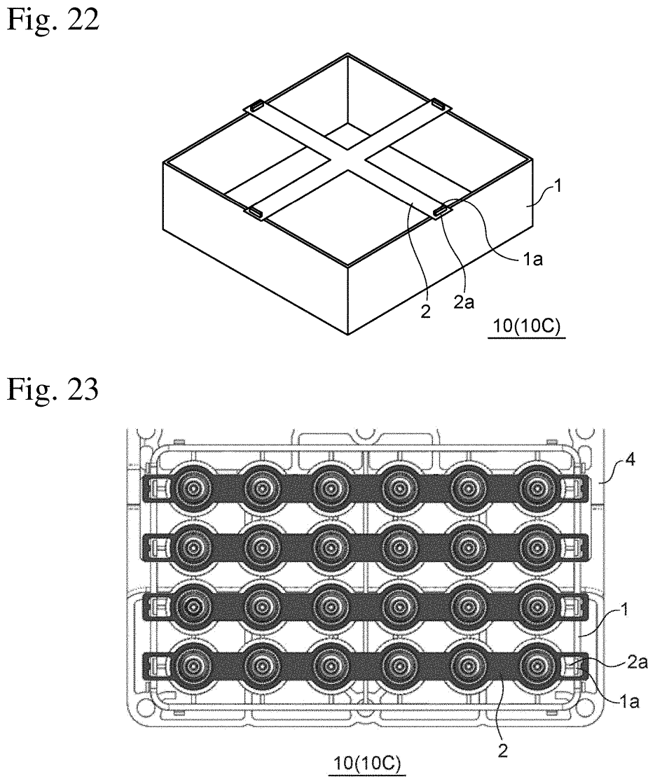

The form of “engagement and disengagement of the members” is an engagement form such as illustrated in FIG. 20 to FIG. 24, and is a form in which the projecting part 32 provided on the ST member 1 engages with the engaging hole 2a provided in the CC member 2 (FIG. 20 and FIG. 21) or a form in which an engaging projection 1a provided on the ST member 1 engages with the engaging hole 2a provided in the CC member 2 (FIG. 22 to FIG. 24), and a form in which these are detached by being disengaged. The projecting part 32 and the engaging projection 1a are preferably provided on the easy-to-process ST member 1, and are preferably formed in a size and a shape suitable for the engagement mode with the engaging hole 2a provided in the CC member 2.

FIG. 20 and FIG. 21 illustrate the part hooking member composed of the ST member 1 and the mounting member composed of the CC member 2 for mounting the part hooking member. As illustrated in FIG. 20, the mounting member is the CC member 2 integrally formed into a form having a hollowed-out opening. This mounting member is provided with a plurality of the engaging holes 2a that engage with projections (projecting parts 32 or engaging projections 1a) of the ST member 1 at a certain interval. The CC member 2 is not limited to an integrally formed member and, as long as provided with the plurality of engaging holes 2a, may be a member configured by intersecting the CC members 2 composed of strip-shaped plate materials such as illustrated in FIG. 18.

On the other hand, the ST member 1 is not limited to the form illustrated in FIG. 21 as long as provided with a projection (projecting part 32 or engaging projection 1a) that engages with the engaging hole 2a of the CC member 2. In particular, the projecting part 32 is not necessarily a circular form illustrated in FIG. 21, and may have various projecting forms such as a quadrangle, a triangle, and an ellipse. Further, the number of the projecting parts 32 is also not limited to the one illustrated in FIG. 21, as long as engagement with the engaging hole 2a and other structural portions of the corresponding CC member 2 is possible, and may be two, three, four, or the like. The ST member 1 and the CC member 2 are engaged with each other by forming the projecting part 32 or the engaging projection 1a and the engaging hole 2a in sizes that take into consideration thermal expansion during heat treatment. It should be noted that the mounting member composed of the ST member 1 is a member on which the part to be heat-treated can be placed or hooked, and the form thereof is not limited to a form extending upward such as in FIG. 21, may be the cylindrical form illustrated in FIGS. 17A and 17B, and is not particularly limited.

FIG. 22 is an example of the heat treatment member 10C in which the ST member 1 and the CC member 2 are engaged with each other. This engagement form is also, as described above, a form in which the engaging projection 1a provided on the ST member 1 engages with the engaging hole 2a provided in the CC member 2, and a form in which these are detached by being disengaged. The engaging projection 1a is provided on the easy-to-process ST member 1, and is formed in a size that takes into consideration thermal expansion during heat treatment, making engagement with the engaging hole 2a provided in the CC member 2 possible. In FIG. 22, the ST member 1 exemplifies a basket-type mounting member, but the ST member 1 is not limited to such a form as long as provided with a similar engagement form, and may have various forms. Further, the CC member 2 exemplifies a cross-shaped structural form, but the CC member 1 is not limited to such a form as long as provided with a similar engagement form, and may have various forms. In FIG. 22, the CC member 2, which is less susceptible to thermal deformation and the like, is engaged so as to restrain the thermal deformation of the opening frame of the ST member 1 in the vertical and horizontal directions, making it possible to maintain the form of the opening frame during heat treatment. When the ST member 1 is deformed by repeated heat treatment and is to be replaced, it is possible to replace the ST member 1 only, and repeatedly reutilize the CC member 2 less susceptible to thermal deformation and the like.

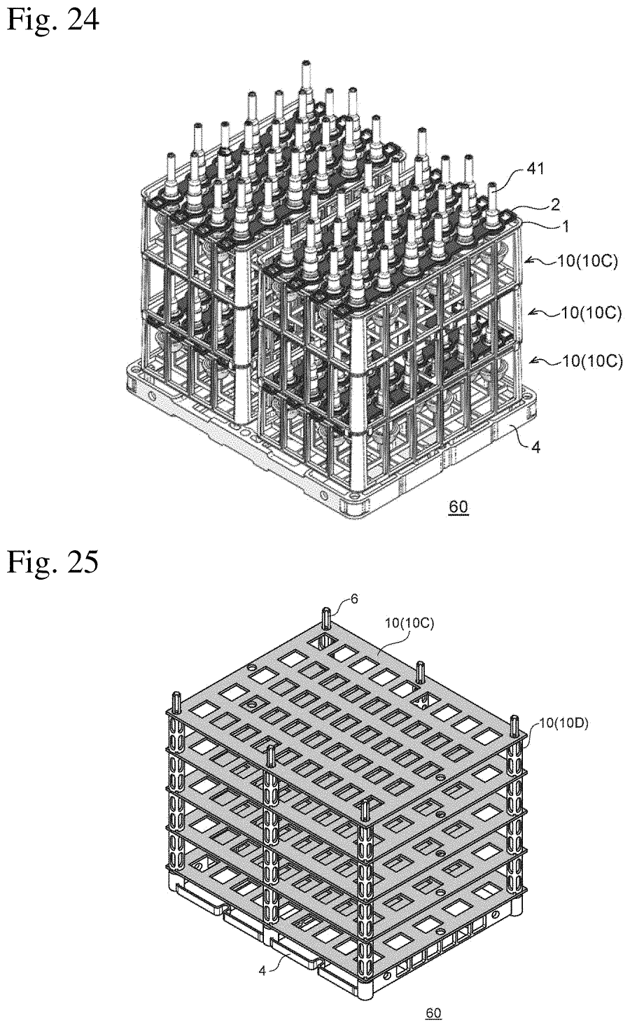

FIG. 23 is an example of the heat treatment member 10C in which a vibration-halting prevention member composed of the CC member 2 and a mounting member (including an opening frame) composed of the ST member 1 are engaged with each other, and FIG. 24 is an example of the heat treatment structure 60 having the structural form of FIG. 23. Examples of this ST member 1 include a mounting member including an opening frame. This engagement form is also, as in the form of FIG. 22, a form in which the engaging projection 1a provided on the ST member 1 engages with the engaging hole 2a provided in the CC member 2, and a form in which these are detached by being disengaged. The engaging projection 1a is provided on the easy-to-process ST member 1, and is formed in a size and a shape that make engagement with the engaging hole 2a provided in the CC member 2 possible. In FIG. 23, as in FIG. 22, the ST member 1 exemplifies a basket-type mounting member. The CC member 2 has a structural form that is provided with holes at a certain interval in a plate material having a strip shape and extending in one direction and, with the part to be heat-treated inserted into the holes, has the function of preventing the halting of vibration of a part 41 to be heat-treated. Such a vibration-halting prevention member is a member for preventing the halting of vibration of the part 41 to be heat-treated and thus, in the form of FIG. 23, the engaging hole 2a of the CC member 2 is formed larger than the engaging projection 1a of the ST member 1 so that both are engaged with each other. Accordingly, at the location where the engaging projection 1a is provided, thermal deformation in the ST member 1 is allowed within a certain degree of range, and the engaging hole 2a is formed in such a size. When the ST member 1 is deformed by repeated heat treatment and is to be replaced, it is possible to replace the ST member 1 only, and repeatedly reutilize the CC member 2 less susceptible to thermal deformation and the like.

FIG. 25 is a perspective view illustrating an example of the heat treatment structure 60 obtained by combining the mounting member 10C for mounting the part to be heat-treated and the stacking auxiliary member 10D for stacking the mounting member 10C. This heat treatment structure 60 is configured by mounting the mounting member 10C composed of the CC member on the base member 4 composed of the ST member, subsequently inserting the support column member 6 composed of the ST member into a hole in a corner or the like of the base member 4, subsequently providing the mounting member 10C composed of the CC member via the stacking auxiliary member 10D composed of the ST member, and repeating such a combination form. The stacking auxiliary member 10D composed of the ST member is, in a case in which the tray-shaped mounting member 10C is vertically stacked, a member sandwiched therebetween. The heat treatment structure configured in this way can be saved in weight as a whole and used for a prolonged period of time while replacing the ST member as needed.

As described above, according to a heat treatment member and a heat treatment structure according to the present invention, even when repeatedly loaded into a heat treating furnace with a part to be heat-treated placed thereon, hooked thereto, or the like in order to heat-treat the part to be heat-treated, it is possible to suppress the occurrence of deformation, cracking, and the like, allowing use for a prolonged period of time, and further perform uniform and sufficient carburizing treatment of the part to be heat-treated.

### DESCRIPTIONS OF REFERENCE NUMERALS

1 ST member (Member composed of steel material or Ni alloy material)
1a Engaging projection
2 CC member (Member composed of carbon composite material)
2a Engaging hole
4 Base member
4a Reinforcement hole
4b Space part
6 Support column member
7 Detachable member
8 Coupling member
9 Hole
10 Heat treatment member
10A, 10A′ Hooking member
10B, 10B′ Support member
10C, 10C′ Mounting member
10D, 10D′ Stacking auxiliary member
10E, 10E′ Support column member
30 Screw fastening member or welding auxiliary member
32 Projecting part
33 Welded part
34 Contacting part
41 Part to be heat-treated
60, 60′ Heat treatment structure

1. A heat treatment member constituting a heat treatment structure repeatedly loaded into a heat treating furnace with a part to be heat-treated placed thereon or hooked thereto, comprising:
a member composed of a steel material or a Ni alloy material; and
a member composed of a carbon composite material,
the member composed of a steel material or a Ni alloy material and the member composed of a carbon composite material being detachably combined.

2. The heat treatment member according to claim 1, wherein
the member composed of a steel material or a Ni alloy material is a member fabricated by a lost wax process.

3. The heat treatment member according to claim 1, wherein
the heat treatment member is a hooking member for hooking the part to be heat-treated, a support member for supporting the hooking member, a mounting member for mounting the part to be heat-treated, a stacking auxiliary member for stacking each of these members, or a support column member for stacking each of these members.

4. The heat treatment member according to claim 1, wherein
a member detachably mounted on another member (including another heat treatment member) among the heat treatment members is the member composed of a steel material or a Ni alloy material.

5. The heat treatment member according to claim 1, wherein
the member composed of a steel material or a Ni alloy material and the member composed of a carbon composite material are attached and detached by means selected from screw fastening and unfastening using a screw fastening member, welding and welded-part removal using a welding auxiliary member, and engagement and disengagement of the members.

6. A heat treatment structure repeatedly loaded into a heat treating furnace with a part to be heat-treated placed thereon or hooked thereto, comprising:
a heat treatment member that is, in part or in whole, the heat treatment member described in claim 1.
